(19) United States
(12) Patent Application Publication
(10) Pub. No.: US 2012/0313330 A1
(43) Pub. Date: Dec. 13, 2012

(54) GASKET HAVING A CLOSED BULB AND METHOD FOR MAKING THE SAME

(76) Inventors: Eric Lloyd Scalf, Louisville, KY (US); Robert Thomas Mills, Louisville, KY (US)

(21) Appl. No.: 13/155,415

(22) Filed: Jun. 8, 2011

(51) Int. Cl. F16J 15/06; B29C 45/00; F16J 15/10; F16J 15/02

(52) U.S. Cl. 277/631; 277/641; 264/328.2; 156/245

(57) ABSTRACT

A molded gasket includes a base having an upper surface and a lower surface. The base includes a first portion and a second portion. A bulb portion is integrally formed with the base and extends from the upper surface of the base. The gasket further includes a dart assembly integrally formed with the base and extending from the lower surface of the base. The dart assembly includes a first barb portion extending from the first portion of the base and a second barb portion extending from the second portion of the base.

### BACKGROUND OF THE INVENTION

The embodiments described herein relate generally to a gasket having a closed bulb and, more particularly, to a molded gasket having a closed bulb.

At least some known gaskets are elongated for use as a seal along an end portion of a door or other suitable component. More specifically, such gaskets are configured as strips of material that are shaped to form a seal between the door and another surface. An elongated gasket used to seal a door would typically follow along the end portion of the door and, as such, would include corners, curves, and/or other non-linear contours. At least some known elongated gaskets are shaped to a predetermined contour by a mitering process, an extruding process, or a molding process.

At least one known mitering process includes miter cutting a strip of gasket to form an angle between two strips of gasket. Such a method provides a closed bulb gasket, but may not allow for forming certain curves or complex paths. At least one known extrusion process includes using an extrusion die to create intricate and/or complex cross sections. Such a process can create closed cavities within the gasket, such as a closed bulb. However, the strip of gasket is only extruded in straight sections and may require cutting and/or mitering. A known molding process includes injection molding, which may be used to form a gasket. Such a molding process enables creation of corners, edges, out of plane features, and/or other complex geometries. However, such a molding process cannot form closed cavities within the gasket.

### BRIEF SUMMARY OF THE INVENTION

In one aspect, a molded gasket is provided. The gasket includes a base having an upper surface and a lower surface. The base includes a first portion and a second portion. A bulb portion is integrally formed with the base and extends from the upper surface of the base. The gasket further includes a dart assembly integrally formed with the base and extending from the lower surface of the base. The dart assembly includes a first barb portion extending from the first portion of the base and a second barb portion extending from the second portion of the base.

In another aspect, an appliance is provided. The appliance includes a surface having a channel defined therein and at least one flange extending partially across an upper end of the channel. A gasket is configured to couple to the surface at the channel. The gasket includes a base having an upper surface and a lower surface. The base includes a first portion and a second portion. The gasket further includes a bulb portion integrally formed with the base and extending from the upper surface of the base and a dart assembly integrally formed with the base and extending from the lower surface of the base. The dart assembly includes a first barb portion extending from the first portion of the base and a second barb portion extending from the second portion of the base. The dart assembly is configured to be inserted into the channel, and at least one of the first barb portion and the second barb portion is configured to engage the at least one flange to secure the gasket within the channel.

In yet another aspect, a method for making a gasket is provided. The gasket includes a base having an upper surface and a lower surface, wherein the base includes a first portion and a second portion, a bulb portion extending from the upper surface of the base, and a dart assembly extending from the lower surface of the base, wherein the dart assembly includes a first barb portion extending from the first portion of the base and a second barb portion extending from the second portion of the base. The method includes providing a mold configured to define an exterior surface of the gasket and inserting a tool into the mold. The tool is configured to define an interior surface of the gasket. Material is inserted into the mold about the tool to form the gasket, the tool is removed from the gasket at a gap defined between the first barb portion and the second barb portion.

### BRIEF DESCRIPTION OF THE DRAWINGS

FIGS. 1-6 show exemplary embodiments of the apparatus and methods described herein.

FIG. 1 is a front view of an exemplary appliance.

FIG. 2 is a front view of an exemplary ice-maker assembly that may be used with the appliance shown in FIG. 1.

FIG. 3 is a cross-sectional side view of an exemplary gasket that may be used with the ice-maker assembly shown in FIG. 2.

FIG. 4 is a cross-sectional side view of the gasket shown in FIG. 3 installed in the ice-maker assembly show in FIG. 2.

FIG. 5 is a cross-sectional view of an exemplary molding assembly for making the gasket shown in FIGS. 3 and 4.

FIG. 6 is a flowchart of an exemplary method for making and/or otherwise manufacturing the gasket shown in FIGS. 3 and 4 using the molding assembly shown in FIG. 5.

### DETAILED DESCRIPTION OF THE INVENTION

The embodiments described herein provide molded gaskets that include a closed bulb. Further, a method for making a closed bulb gasket from a molded gasket is described herein. More specifically, the embodiments described herein include the advantages of an extrusion process and a molding process by providing a gasket that includes a closed bulb and can be molded into a predetermined shape. Specifically, the herein-described gasket includes two dart-shaped halves, or barb portions, that can be adhered, bonded, and/or coupled together to form a closed bulb portion and a dart portion. The gaskets described herein may be used in a refrigeration application to seal air gaps around doors; however, the gaskets described herein may be used in any product, appliance, automotive application, water-related application, small electronics, and/or any other suitable applications in which a closed bulb gasket can be used.

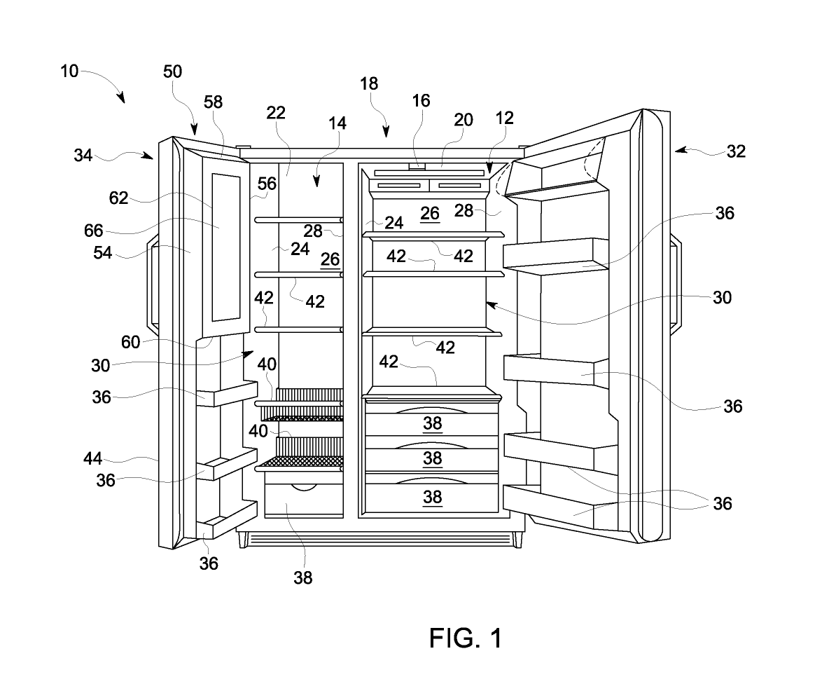

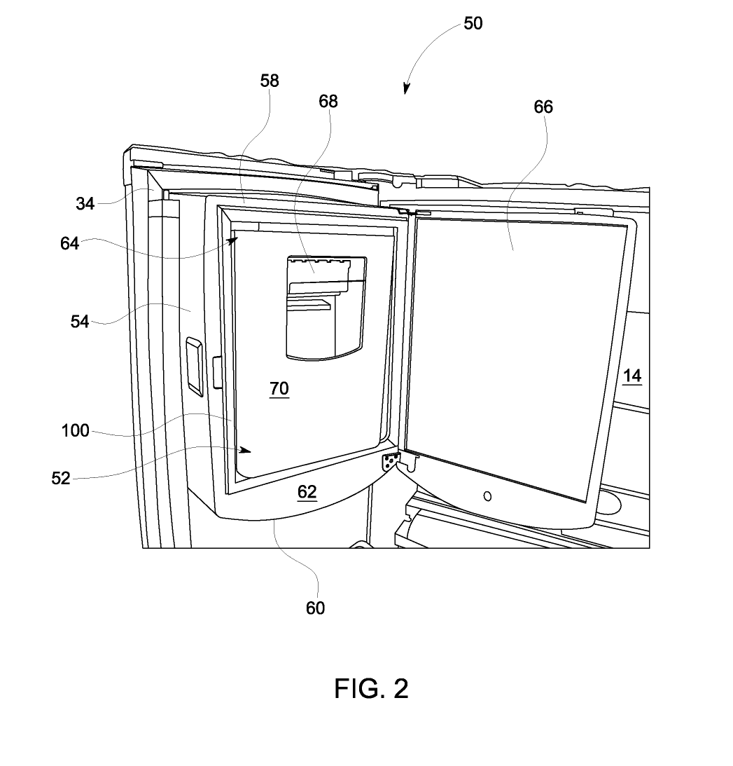

FIG. 1 is a front view of an exemplary appliance, such as a refrigeration appliance 10. FIG. 2 is a front view of an exemplary ice-maker assembly 50 that may be used with appliance 10. Although refrigeration appliance 10 is described herein as a side-by-side refrigerator and freezer, it should be understood that the benefits of the embodiments described herein may be achieved in other types of refrigeration appliances, such as over-and-under refrigerators and freezers, stand-alone refrigerators, and/or stand-alone freezers. Further, it should be understood that the benefits of the herein-described embodiments may be achieved in other types of appliances, automotive application, water-related application, marine application, small electronics, and/or any other suitable applications.

In the exemplary embodiment, refrigeration appliance 10 includes a fresh food storage compartment 12, also referred to as a “refrigerator,” and a freezer storage compartment 14. A controller 16 is mounted within refrigeration appliance 10, and is programmed to control temperatures within fresh food storage compartment 12 and/or freezer storage compartment 14. As used herein, the term “controller” is not limited to just those integrated circuits referred to in the art as microprocessor, but broadly refers to computers, processors, microcontrollers, microcomputers, programmable logic controllers, application specific integrated circuits, and other programmable circuits, and these terms are used interchangeably herein.

Refrigeration appliance 10 also includes a machinery compartment (not shown) that at least partially contains components for executing a known vapor compression cycle for cooling air. The components include, but are not limited to including, a compressor (not shown), a condenser (not shown), an expansion device (not shown), and an evaporator (not shown) connected in series and charged with a refrigerant. The evaporator provides cool air that is used to refrigerate fresh food storage compartment 12 and/or freezer storage compartment 14 via fans (not shown). Collectively, the vapor compression cycle components in a refrigeration circuit, associated fans, and associated storage compartments 12 and/or 14 are referred to herein as a “sealed system.” The sealed system is operable to force cold air through refrigeration appliance 10.

In the exemplary embodiment, fresh food storage compartment 12 and freezer compartment 14 are positioned within an outer case 18 and include inner liners 20 and 22, respectively. Fresh food storage compartment 12 and freezer storage compartment 14 each include a plurality of interior walls, such as a first side wall 24, a rear wall 26, and a second side wall 28, formed from a respective inner liner 20 or 22. Walls 24, 26, and 28 at least partially define a cavity 30 of each storage compartment 12 and 14. The exemplary embodiment includes two separate inner liners 20 and 22 to add strength and to maintain manufacturing tolerances. Alternatively, a single liner is formed and a mullion spans between opposite sides of the liner to divide it into freezer storage compartment 14 and fresh food storage compartment 12.

A fresh food door 32 and a freezer door 34 close access openings to fresh food storage compartment 12 and freezer storage compartment 14, respectively, and at least partially define a respective cavity 30. Each door 32 and 34 is rotatable about its outer vertical edge between an open position, as shown in FIG. 1, and a closed position (not shown) closing the associated storage compartment. Freezer door 34 includes at least one shelf/bin assembly 36, and fresh food door 32 also includes at least one shelf/bin assembly 36. Alternatively, freezer door 34 does not include shelf/bin assembly 36. Further, in the exemplary embodiment, fresh food storage compartment 12 and freezer storage compartment 14 each includes slide-out drawers 38 to support items being stored therein. Further, freezer storage compartment 14 includes drawers 40 formed from a wire lattice. Alternatively, storage compartment 12 and/or 14 does not include drawers 38 and/or 40. In the exemplary embodiment, storage compartments 12 and 14 each include at least one shelf assembly 42. In the exemplary embodiment, shelf assemblies 42 are supported within fresh food storage compartment 12 and/or freezer storage compartment 14 on at least one interior wall 24, 26, and/or 28.

At least one door 32 and/or 34 further includes an ice-maker assembly 50. In the exemplary embodiment, ice-maker assembly 50 is mounted on freezer door 34. When freezer door 34 closes freezer storage compartment 14, ice-maker assembly 50 is positioned within freezer storage compartment 14. Ice-maker assembly 50 is configured to make ice, store ice, and/or dispense ice. When ice-maker assembly 50 is configured to dispense ice, ice is dispensed through a front face 44 of freezer door 34 with freezer door 34 in a closed position.

Ice-maker assembly 50 includes a compartment 52 configured to store and/or dispense ice. Compartment 52 includes side walls 54 and 56, a top wall 58, and a bottom wall 60. A front face 62 of compartment 52 is coupled to and/or integrally formed with walls 54, 56, 58, and/or 60, and an access opening 64 is defined in front face 62. An access door 66 is hingedly coupled to at least one wall 54, 56, 58, and/or 60 and/or front face 62 for closing access opening 64 and allowing access to access opening 64. A gasket 100 surrounds access opening 64 and is configured to form a seal between front face 62 and access door 66 when access door 66 is in a closed position. Gasket 100 is described in more detail below.

An ice maker 68 is positioned within compartment 52. In the exemplary embodiment, ice maker 68 is coupled to a water supply and configured to make ice from water supplied by the water supply. As ice is made, ice maker 68 directs ice into compartment 52 for storage and/or dispensing. Compartment 52 includes a bucket 70 that is removable and/or hingedly coupled to at least one wall 54, 56, 58, and/or 60 of compartment 52. In the exemplary embodiment, bucket 70 is configured to retain ice within compartment 52 when access door 66 is in an open position. Bucket 70 is removed and/or rotated to allow access to ice within compartment 52. In an alternative embodiment, compartment 52 includes a bin, drawers, and/or any other suitable containment device in addition, or as an alternative, to bucket 70. Alternatively, bucket 70 is omitted.

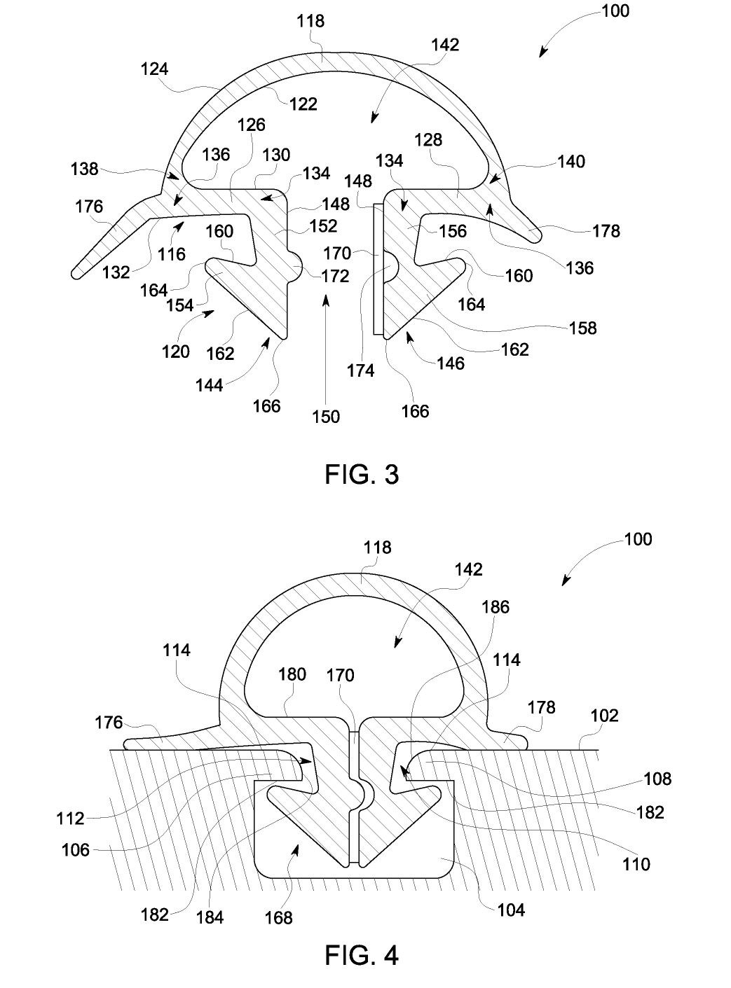

FIG. 3 is a cross-sectional side view of an exemplary gasket 100 that may be used with ice-maker assembly 50 (shown in FIGS. 1 and 2). FIG. 4 is a cross-sectional side view of gasket 100 installed in ice-maker assembly 50. Although gasket 100 is described as being used with ice-maker assembly 50, it should be understood that gasket 100 can be used at any suitable location of appliance 10 and/or in any suitable sealing application. In the exemplary embodiment, appliance 10 includes a surface 102, such as front face 62 (shown in FIGS. 1 and 2), having a channel 104 defined therein. Channel 104 is configured to receive at least a portion of gasket 100 therein for securing gasket 100 to surface 102. At least one flange extends partially across an upper end 110 of channel 104. In the exemplary embodiment, a pair of opposing flanges 106 and 108 extend across upper end 110 of channel 104 with a slot 112 defined therebetween. Slot 112 is configured to receive at least a portion of gasket 100, and flanges 106 and 108 are configured to engage at least portion of gasket 100 for securing gasket 100 within channel 104. In the exemplary embodiment, an upper surface 114 of each flange 106 and 108 is substantially co-planar with surface 102. Alternatively, flanges 106 and/or 108 have any suitable configuration that enables appliance 10 and/or gasket 100 to function as described herein.

In the exemplary embodiment, gasket 100 is molded from silicone, an elastomeric material, and/or any other suitable material. Gasket 100 is configured to couple to surface 102 and channel 104 to provide a seal between surface 102 and another surface, such as access door 66 (shown in FIGS. 1 and 2). More specifically, gasket 100 includes a base 116, a bulb portion 118, and a dart assembly 120 integrally formed as one-piece using any suitable molding process. Further, gasket 100 includes an interior surface 122 and an exterior surface 124, as described in more detail below.

Base 116 includes a first portion 126 and a second portion 128, which is substantially a mirror image of first portion 126. Alternatively, first portion 126 and second portion 128 are configured differently than each other and/or have any suitable configuration that enables gasket 100 to function as described herein. In the exemplary embodiment, base 116 has an upper surface 130 and a lower surface 132. Upper surface 130 is a portion of interior surface 122 of gasket 100, and lower surface 132 is a portion of exterior surface 124 of gasket 100. Each portion 126 128 have upper surface 130 and lower surface 132. Further, first portion 126 and second portion 128 each include an inner end 134 and an opposing outer end 136. Inner ends 134 of first portion 126 and second portion 128 are proximate each other.

Bulb portion 118 extends from upper surface 130 of base 116. More specifically, a first end 138 of bulb portion 118 is proximate to outer end 136 of base first portion 126, and a second end 140 of bulb portion 118 is proximate outer end 136 of base second portion 128. Alternatively, first end 138 of bulb portion 118 is at any suitable location with respect to base first portion 126 and/or second end 140 of bulb portion 118 is at any suitable location with respect to base second portion 128. In the exemplary embodiment, bulb portion 118 is continuous between first end 138 and second end 140. More specifically, bulb portion 118 is shaped as a continuous arc between first end 138 and second end 140. Alternatively, bulb portion 118 has any suitable shape that enables gasket 100 to function as described herein. In an alternative embodiment, bulb portion 118 is not continuous between first end 138 and second end 140. In the exemplary embodiment, bulb portion 118 and base 116 define a bulb 142 of gasket 100. Bulb 142 is configured to retain a gas, such as air, therein to facilitate increasing thermal performance of gasket 100. For example, bulb 142 is configured as a thermal break that slows or blocks thermal transfer across gasket 100.

Dart assembly 120 extends from lower surface 132 of base 116 and includes a first barb portion 144 and a second barb portion 146. First barb portion 144 extends from base first portion 126, and second barb portion 146 extends from base second portion 128. More specifically, first barb portion 144 extends from first portion 126 proximate to inner end 134 of first portion 126, and second barb portion 146 extends from second portion 128 proximate to inner end 134 of second portion 128. Alternatively, first barb portion 144 extends from first portion 126 at any suitable location that enables gasket 100 to function as described herein, and/or second barb portion 146 extends from second portion 128 at any suitable location that enables gasket 100 to function as described herein. In the exemplary embodiment, dart assembly 120 is configured to be inserted in channel 104 to secure gasket 100 to surface 102. More specifically, first barb portion 144 and second barb portion 146 are configured to engage flange 106 and 108, respectively, to secure gasket 100 within channel 104.

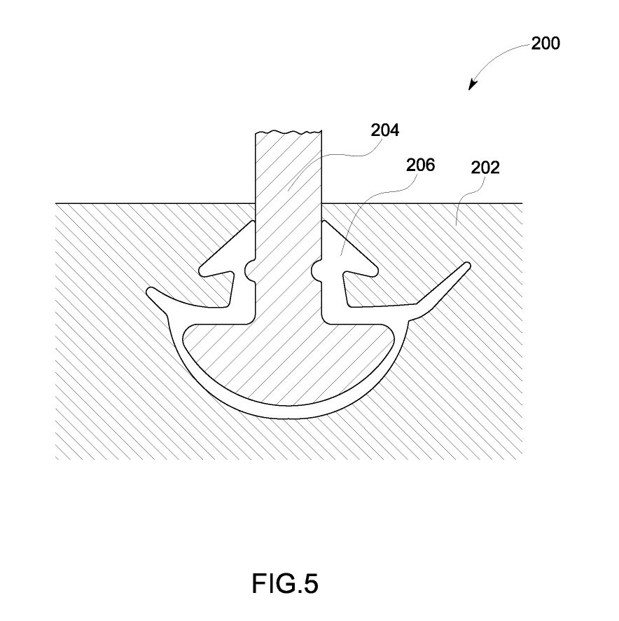

Each barb portion 144 and 146 includes an inner surface 148, which is a portion of interior surface 122 of gasket 100. A gap 150 is defined between inner surface 148 of first barb portion 144 and inner surface 148 of second barb portion 146. As such, gap 150 is also defined between base first portion 126 and/or base second portion 128 at, for example, inner ends 134. Gap 150 is formed by a tool 204 (shown in FIG. 5) used to make gasket 100, as described in more detail below. Although gap 150 is described as being formed between first barb portion 144 and second bulb portion 146, gap 150 can be defined at any suitable location along a cross-section of gasket 100. For example, gap 150 is defined through any suitable portion of bulb portion 118 and/or through any suitable portion of base 116. In the exemplary embodiment, inner surfaces 148 are configured to be adjacent each other when gasket 100 is coupled within channel 104. As used herein, the term “adjacent” refers to at least two components and/or surfaces that are in direct contact with each other and/or positioned side-by-side in spaced relation to each other.

First barb portion 144 includes a neck 152 and a barb 154, and second barb portion 146 includes a neck 156 and a barb 158. Barbs 154 and 158 are substantially mirror images of each other; however, barb 154 and/or 158 can have any suitable shape and/or configuration that enables gasket 100 to function as described herein. In the exemplary embodiment, each barb 154 and 158 is generally triangularly shaped with an upper surface 160 and a lower surface 162 that are connected at an outer apex 164. Upper surfaces 160 and lower surfaces 162 are portions of exterior surface 124. Neck 152 is defined between base first portion 126 and upper surface 160 of first barb 154, and neck 156 is defined between base second portion 128 and upper surface 160 of second barb 158. Lower surfaces 162 connect with inner surfaces 148 at a respective lower apex 166. Lower apexes 166 distinguish interior surface 122 of gasket 100 from exterior surface 124 of gasket 100. More specifically, as used herein, any surface of gasket 100 within an interior portion of gasket 100 extending at least partially between lower apexes 166 is referred to as interior surface 122, and any surface of gasket 100 defining an exterior portion of gasket 100 extending at least partially between lower apexes 166 is referred to as exterior surface 124. Interior surface 122 is continuous with exterior surface 124.

In the exemplary embodiment, first barb portion 144 and second barb portion 146 are configured to be coupled together to form a dart 168 configured to be received within channel 104. The coupling of barb portions 144 and 146 can be permanent or temporary. Further, the coupling can be localized to a particular location or locations along inner surfaces 148 or can be continuous along inner surfaces 148. More specifically, in one embodiment, first barb portion 144 and second barb portion 146 are coupled together by forces applied to first barb portion 144 and/or second barb portion 146 by surfaces of channel 104, flange 106, and/or flange 108. In particular embodiments, first barb portion 144 and second barb portion 146 are coupled together using any suitable bonding material and/or coupling technique. Such bonding is performed before and/or after dart 168 is inserted into channel 104. In the exemplary embodiment, a bonding material 170, such as adhesive, is applied to inner surface 148 of first barb portion 144 and/or inner surface 148 of second barb portion 146 to couple barb portions 144 and 146 together. Alternatively, barb portions 144 and 146 are coupled together using a homogenous material, room temperature vulcanizing (RTV), hotmelt, a rivet, a heatstake, melting, and/or any other suitable coupling mechanism and/or technique that enables barb portions 144 and 146 to be spliced together. Alternatively, or additionally, inner ends 134 of base portions 126 and 128 are coupled together using any suitable coupling mechanism and/or technique.

Dart assembly 120 further includes an alignment mechanism, such as a ridge 172 and a groove 174. Ridge 172 extends from inner surface 148 of first barb portion 144, and groove 174 is defined in inner surface 148 of second barb portion 146. Ridge 172 and groove 174 facilitate aligning barb portions 144 and 146 for coupling barb portions 144 and 146 together. More specifically, groove 174 is configured to receive ridge 172 to align first barb portion 144 with second barb portion 146. Alternatively, dart assembly 120 includes any suitable structure(s) for aligning barb portions 144 and 146 and/or base portions 126 and 128. In an alternative embodiment, dart assembly 120 does not include any alignment mechanism, such as ridge 172 and groove 174.

Gasket 100 further includes, in the exemplary embodiment, a first sealing flange 176 and a second sealing flange 178. First sealing flange 176 extends from outer end 136 of base first portion 126, and second sealing flange 178 extends from outer end 136 of base second portion 128. Sealing flanges 176 and 178 are configured to prevent a material and/or substance from entering channel 104. For example, sealing flanges 176 and 178 prevent air, debris, and/or liquids from entering channel 104 when gasket 100 is coupled to channel 104. In the exemplary embodiment, first sealing flange 176 is longer than second sealing flange 178. Further, first sealing flange 176 extends from base 116 and an angle, and second sealing flange 178 includes a curved lower surface; however, it should be understood that first sealing flange 176 and/or second sealing flange 178 have any suitable configuration that enables gasket 100 to function as described herein. For example, sealing flanges 176 and 178 can be substantially mirror images of each other. Alternatively, gasket 100 does not include first sealing flange 176 and/or second sealing flange 178.

Referring to FIG. 4, when gasket 100 is coupled within channel 104, bulb 142 is a closed bulb having a bottom wall 180 formed by first portion 126 and second portion 128 of base 116. Further, barb portions 144 and 146 form dart 168, which is coupled within channel 104 and engages and/or interlocks with flanges 106 and/or 108. More specifically, upper surfaces 160 of barb portions 144 and 146 are positioned adjacent lower surfaces 182 of flanges 106 and 108. Further, neck 152 is positioned adjacent an inner end 184 of first flange 106, and neck 156 is positioned adjacent an inner end 186 of second flange 108. Sealing flanges 176 and 178 contact a portion of surface 102 to form a seal between the environment and channel 104.

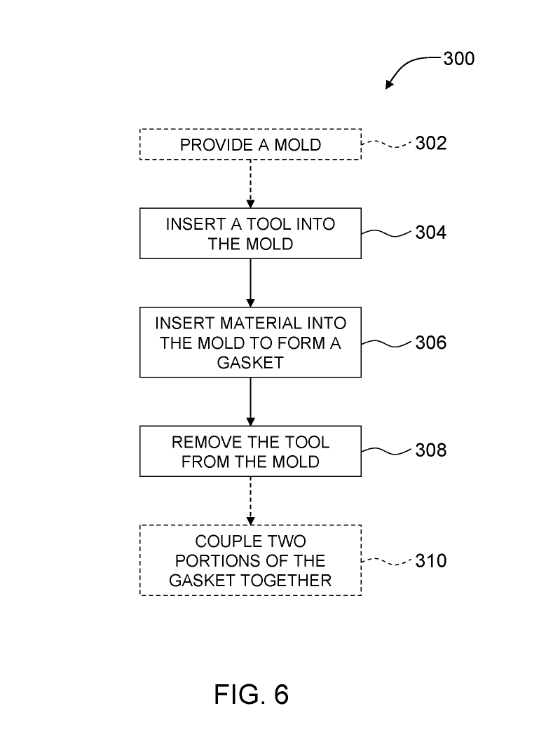

FIG. 5 is a cross-sectional view of an exemplary molding assembly 200 for making gasket 100 (shown in FIGS. 3 and 4). FIG. 6 is a flowchart of an exemplary method 300 for making and/or otherwise manufacturing gasket 100 using molding assembly 200. The steps of method 300 can be performed in any suitable order depending on the type of molding procedure used to form gasket 100. Referring to FIGS. 3 and 5, molding assembly 200 includes a mold 202 configured to define exterior surface 124 of gasket 100 and a tool 204 configured to define interior surface 122 of gasket 100. Referring to FIGS. 3-6, method 300 includes providing 302 mold 202. As used herein, the term “providing,” or variations thereof, refers to supplying, furnishing, preparing, presenting, procuring, purchasing, transferring, producing, manufacturing, fabricating, forging, machining, molding, constructing, and/or any other suitable means to provide a component.

Method 300 further includes inserting 304 tool 204 into mold 202 and inserting 306 material into mold 202. In one embodiment, tool 204 is inserted 304 into mold 202 before the material is inserted 306 into mold 202 such that a void 206 is defined between mold 202 and tool 204. Mold 202 and/or tool 204 is flexible to enable tool 204 to be inserted 304 into mold 202. Alternatively, mold 202 is formed from more than one piece to enable tool 204 to be inserted into mold 202. In an alternative embodiment, the material is inserted 306 into mold 202 before tool 204 is inserted 304 into mold 202. In the exemplary embodiment, when the material is inserted 306 into mold 202, the material conforms to the shape of void 206. As such, the material is inserted 306 into mold 202 and about tool 204 to form gasket 100. After an appropriate duration of time, such as a curing period, tool 204 is removed 308 from mold 202. For example, tool 204 is removed from gasket 100 at gap 150. Gasket 100 is also removed from mold 202. Alternatively, gasket 200 is removed from mold 202 with tool 204. In a particular embodiment, the pieces of mold 202 are separated to remove tool 204 and/or gasket 100 from mold 202.

In a particular embodiment, two portions of gasket 100, such as barb portions 144 and 146, are coupled 310 together before gasket 100 is coupled to channel 104. To couple 310 barb portions 144 and 146 together, bonding material 170 is applied to inner surface 148 of first barb portion 144 and/or inner surface 148 of second barb portion 146 and/or inner ends 134 of base portions 126 and 128 are bonded together. To align barb portions 144 and 146 for coupling barb portions 144 and 146 together, ridge 172 is aligned with groove 174. After coupling barb portions 144 and 146 together, dart 168 is inserted into channel 104 and interlocks and/or engages with flanges 106 and/or 108.

The above-described embodiments provide a molded gasket having a closed bulb. The closed bulb provides a better sealing barrier to isolate one area from another, as compared to gaskets that do not include a bulb and/or include an open bulb. As such, the gasket described herein provides a better seal than open bulbs between different temperature zones, such as temperature zones within a refrigeration appliance. Further, the closed bulb maintains holds its form better than open bulbs and prevents rollover during compression. Moreover, the molded gasket described herein is more aesthetically-pleasing and/or appearing to be of higher quality than extruded gaskets. Additionally, the alignment mechanism described herein facilitates coupling at least two portions of the gasket together to form the closed bulb and/or coupling the dart within the channel.

Exemplary embodiments of a gasket having a closed bulb and method for making the same are described above in detail. The methods and apparatus are not limited to the specific embodiments described herein, but rather, components of apparatus and/or steps of the methods may be utilized independently and separately from other components and/or steps described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A molded gasket comprising:
a base having an upper surface and a lower surface, said base comprising a first portion and a second portion;
a bulb portion integrally formed with said base and extending from said upper surface of said base; and
a dart assembly integrally formed with said base and extending from said lower surface of said base, said dart assembly comprising a first barb portion extending from said first portion of said base and a second barb portion extending from said second portion of said base.

2. A gasket in accordance with claim 1, wherein an inner surface of said first barb portion and an inner surface of said second barb portion define a gap therebetween.

3. A gasket in accordance with claim 2, wherein said inner surface of said first barb portion and said inner surface of second barb portion are configured to be adjacent each other when said gasket is installed within a channel.

4. A gasket in accordance with claim 2, further comprising:
a bonding material applied to at least one of said inner surface of said first barb portion and said inner surface of said second barb portion.

5. A gasket in accordance with claim 1, wherein said bulb portion is continuous between said first end of said bulb portion and said second end of said bulb portion, said bulb portion and said base defining a bulb of said gasket.

6. A gasket in accordance with claim 1, further comprising:
a ridge extending from an inner surface of said first barb portion; and
a groove defined in an inner surface of said second barb portion, said groove configured to receive said ridge for aligning said first barb portion and said second barb portion.

7. A gasket in accordance with claim 1, wherein said first barb portion and said second barb portion are configured to be coupled together to form a dart configured to be received within a channel.

8. A gasket in accordance with claim 1, further comprising:
a first sealing flange extending from an outer end of said first portion of said base; and
a second sealing flange extending from an outer end of said second portion of said base.

9. A gasket in accordance with claim 1, wherein:
said first portion of said base and said second portion of said base each comprise an inner end and an outer end;
said first end of said bulb portion is proximate to said outer end of said first portion and said second end of said bulb portion is proximate to said outer end of said second portion;
said first barb portion extends from said first portion of said base proximate to said inner end of said first portion; and
said second barb portion extends from said second portion of said base proximate to said inner end of said second portion.

10. An appliance, comprising:
a surface comprising a channel defined therein and at least one flange extending partially across an upper end of said channel; and
a gasket configured to couple to said surface at said channel, said gasket comprising:
a base having an upper surface and a lower surface, said base comprising a first portion and a second portion;
a bulb portion integrally formed with said base and extending from said upper surface of said base; and
a dart assembly integrally formed with said base and extending from said lower surface of said base, said dart assembly comprising a first barb portion extending from said first portion of said base and a second barb portion extending from said second portion of said base, said dart assembly configured to be inserted into said channel and at least one of said first barb portion and said second barb portion configured to engage said at least one flange to secure said gasket within said channel.

11. An appliance in accordance with claim 10, wherein said bulb portion and said base define a bulb of said gasket, said bulb substantially closed when said gasket is coupled within said channel.

12. An appliance in accordance with claim 10, wherein said bulb portion is continuous between said first end of said bulb portion and said second end of said bulb portion.

13. An appliance in accordance with claim 10, wherein an inner surface of said first barb portion and an inner surface of second barb portion are configured to be adjacent each other when said gasket is installed within said channel.

14. An appliance in accordance with claim 10, wherein said first barb portion and said second barb portion are coupled together to form a dart configured to be received within said channel.

15. An appliance in accordance with claim 10, wherein a bonding material is applied to at least one of an inner surface of said first barb portion and an inner surface of said second barb portion.

16. A method for making a gasket that includes a base having an upper surface and a lower surface, wherein the base comprises a first portion and a second portion, a bulb portion extending from the upper surface of the base, and a dart assembly extending from the lower surface of the base, wherein the dart assembly comprises a first barb portion extending from the first portion of the base and a second barb portion extending from the second portion of the base, said method comprising:
inserting a tool into the mold, the mold configured to define an exterior surface of the gasket and the tool configured to define an interior surface of the gasket;
inserting material into the mold about the tool to form the gasket; and
removing the tool and the gasket from the mold.

17. A method in accordance with claim 16, further comprising:
coupling the first barb portion and the second barb portion together to form a dart of the gasket.

18. A method in accordance with claim 17, wherein coupling the first barb portion and the second barb portion together further comprises applying a bonding material to at least one of the interior surface of the first barb portion and the interior surface of the second barb portion.

19. A method in accordance with claim 17, wherein coupling the first barb portion and the second barb portion together further comprises bonding the interior surface of the first barb portion to the interior surface of the second barb portion.

20. A method in accordance with claim 17, wherein coupling the first barb portion and the second barb portion together further comprises aligning a ridge extending from the interior surface of the first barb portion with a groove defined in the interior surface of the second barb portion.
